(19) United States
(12) Patent Application Publication
(10) Pub. No.: US 2009/0319420 A1
(43) Pub. Date: Dec. 24, 2009

(54) SYSTEM AND METHOD FOR ASSESSING COMPLIANCE RISK

(76) Inventors: James Sanchez, San Diego, CA (US); Sai Huda, San Diego, CA (US); Elva Coffey-Sears, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/143,681

(22) Filed: Jun. 20, 2008

(51) Int. Cl. G06Q 40/00

(52) U.S. Cl. 705/38

(57) ABSTRACT

Institutional risk is calculated by collecting information about the products and services offered by an institution and assigning a risk value to each product and service. Other aspects and components of an institution are also assigned risk values. The various risk values are calculated along with institutional controls that are in place to mitigate risk in order to determine an overall residual risk assessment for the entity. Forecasts can be made for an institution by adding new or subtracting current business activities and/or institutional controls and calculating an alternative overall residual risk assessment.

### BACKGROUND

1. Field of the Invention

The present invention generally relates to the field of risk assessment and more particularly relates to assessing the compliance risks related to laws and regulations and identifying risk mitigation actions.

2. Related Art

In certain industries various state and federal laws and regulations require compliance by companies that operate in those industries. For example, the banking and financial services industry is heavily regulated. One typical aspect of these regulations is that they require ongoing risk assessment and mitigation of the potential risk.

Today, conventional risk assessment is a subjective process carried out by internal company employees or various external third parties. Typically, it is these same employees or third parties who recommend actions to mitigate identified risk. Conventional risk assessment and identification of mitigating actions is extremely labor intensive and requires specific and detailed knowledge of a complicated tangle of continuously changing laws, regulations, and rules.

Furthermore, conventional risk assessment and mitigation practice suffers from an extreme lack of standardization with respect to the identification of risk and the mitigation of risk and results in very subjective processes implemented on a company by company basis. Therefore, what is needed is a system and method that overcomes these significant problems found in the conventional systems as described above.

### SUMMARY

To address these significant problems, disclosed herein are systems and methods for assessing compliance risk and identifying mitigation actions. The system comprises a database of question elements that operate to solicit and gather information related to the key components of business operations that create risk in a particular industry. In practice, representatives of a company respond to various questions and this information is used by the system to identify and weigh the related inherent risk associated with the business practices of the company. The inherent risk or inherent risk level may be, for example, indicia of risk comprising the institutions financial profile, its chosen product line and its internal factors of operation. These inherent risks are then offset by certain institutional controls that are in place to mitigate risk. The inherent risk and institutional controls are then calculated to determine an overall residual risk assessment. The system may also help to identify appropriate risk mitigation actions (e.g., controls) that can be taken by the company to reduce the risk.

The system and methods described herein also allow individual entities to augment the risk assessment and mitigation process by adding the entity's own internal controls/regulations and custom products to the analysis. Additionally, the system and methods described herein allow an entity to forecast the risk of adding additional products and/or lines of business as well as forecasting the reduction in risk by eliminating particular products and/or lines of business or individual business practices. The system and methods can also be used by an auditor to evaluate an entity. Other features and advantages will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example system for compliance risk assessment according to an embodiment of the present invention;

FIG. 2 is a block diagram illustrating an example risk assessment server according to an embodiment of the present invention;

FIG. 3 is a flow diagram illustrating a high level process for calculating an internal control value according to an embodiment of the present invention;

FIG. 4 is a flow diagram illustrating a high level process for calculating an inherent risk assessment according to an embodiment of the present invention;

FIG. 5 is a flow diagram illustrating a high level process for calculating a residual risk assessment according to an embodiment of the present invention;

FIG. 6 is a flow diagram illustrating a high level process for calculating a forecast risk assessment according to an embodiment of the present invention;

FIG. 7 is an example screen shot of a user interface illustrating a product volume entry according to an embodiment of the present invention;

FIG. 8 illustrates an example screen shot of a user interface for receiving various characteristics for setting up the institutions profile according to an embodiment of the present invention;

FIG. 9 is an example screen shot of a user interface diagram illustrating screens of the various reports that may be generated by the reporting module according to an embodiment of the present invention;

FIG. 10 is an example screen shot of a user interface illustrating a list of products or services associated with a line of business according to an embodiment of the present invention;

FIG. 11 is an example screen shot of a user interface illustrating components of an institution profile according to an embodiment of the present invention;

FIG. 12 is an example screen shot of a user interface for selecting or entering the institution controls in relation to a specific rule according to an embodiment of the present invention;

FIG. 13 is an example screen shot of a user interface institution factors that affect the institution's risk level according to an embodiment of the present invention;

FIG. 14 is a block diagram illustrating an example computer system that may be used in connection with various embodiments described herein.

### DETAILED DESCRIPTION

Certain embodiments as disclosed herein provide for systems and methods to assess the compliance risk of a business entity or institution with respect to the business entity's various business activities relating to, for example, the products, services or processes of the business entity and internal controls established by the business entity to mitigate risks. For example, one method as disclosed herein allows an entity to calculate its overall risk assessment value by providing the compliance risk assessment system with information regarding its business activities and the internal controls put in place by the entity. This information is then used to calculate an overall residual risk assessment value for the business activities of the entity. The entity can also forecast alternative residual risk assessment values by factoring in potential additional business activities and/or internal controls.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

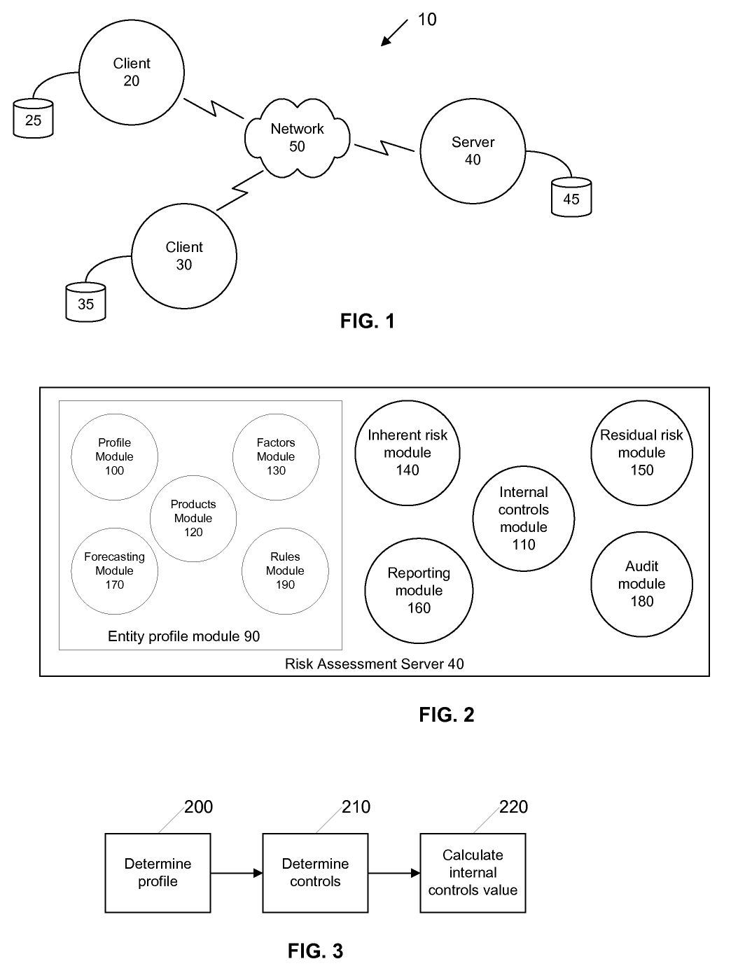

FIG. 1 is a network diagram illustrating an example system for compliance risk assessment according to an embodiment of the present invention. In the illustrated embodiment, the system 10 comprises a server 40, for example a risk assessment server, that is communicatively coupled with client device 20 and client device 30 via a network 50. The server 40, client devices 20 and 30 is configured with data storage area 45, 25 and 35 respectively. The data storage area 25, 35 and 45 can be any sort of internal or external memory device and may include both persistent and volatile memories. The function of the data storage area 45 is to maintain data (e.g., data relating to a business entity activities) for long term storage and also to provide efficient and fast access to instructions for applications that are executed by the server 40. The server 40 and the client devices 20 and 30 are all communicatively coupled with the network 50. The network 50 is configured for data communications (e.g., between server 40 and client device 20) over a wide geographical area and can be communicatively coupled with one or more public or private networks (not shown), which may include that particular aggregation of networks commonly known as the Internet.

The client devices 20 and 30 can also be implemented using a conventional computer device or other communication device with the ability to connect to the network 50. For example, the client devices 20 and 30 can include any of a variety of communication devices including a wireless communication device, personal digital assistant (“PDA”), personal computer (“PC”), laptop computer, PC card, special purpose equipment, or any combination of these and other devices capable of establishing a communication link over network 50 with the server 40.

FIG. 2 is a block diagram illustrating an example risk assessment server according to an embodiment of the present invention. The risk assessment server 40 may include an entity profile module 90, a reporting module 160, an audit module 180, an inherent risk module 140, a residual risk module 150 and an internal controls module 110. The entity profile module 90 may be configured to receive information regarding the business activities and risk mitigation activities of an entity. The entity profile module 90 may include a profile module 100, a factors module 130, a products module 120, a forecasting module 170 and a rules module 190. In some embodiments the internal controls module 110 may be a part of the entity profile module 90. The risk assessment server may be coupled to the storage device or medium 45. The storage device may be configured to store inputs to the system including rules and regulations, laws, factors affecting the business activities, products, services, processes etc. The storage device 45 may be updated based on a schedule (for example daily, hourly or weekly) to incorporate, for example, new or amended laws or regulations as well as current enforcement actions and litigation. The enforcement actions may be arranged as a matrix of risk factors. The risk factors may include actual federal enforcement actions, for example, against institutions quantified to specific risk by regulation and by action. The litigation actions may also be arranged as a matrix of risk comprising actual private legal actions against the institution under federal causes of action, for example, quantified to specific risk factors by regulation and action.

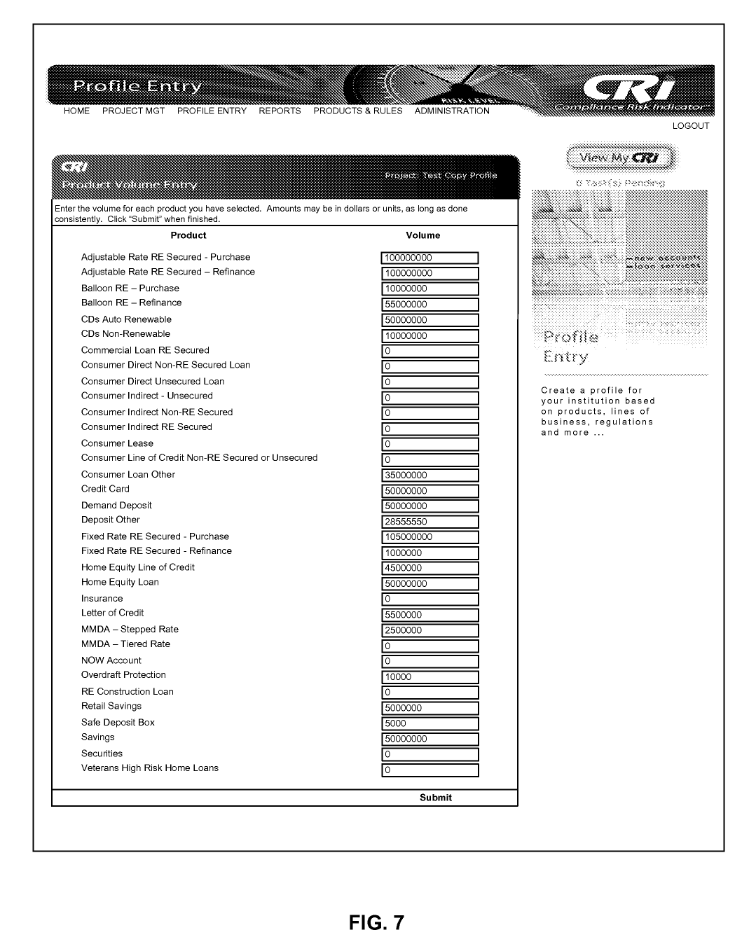

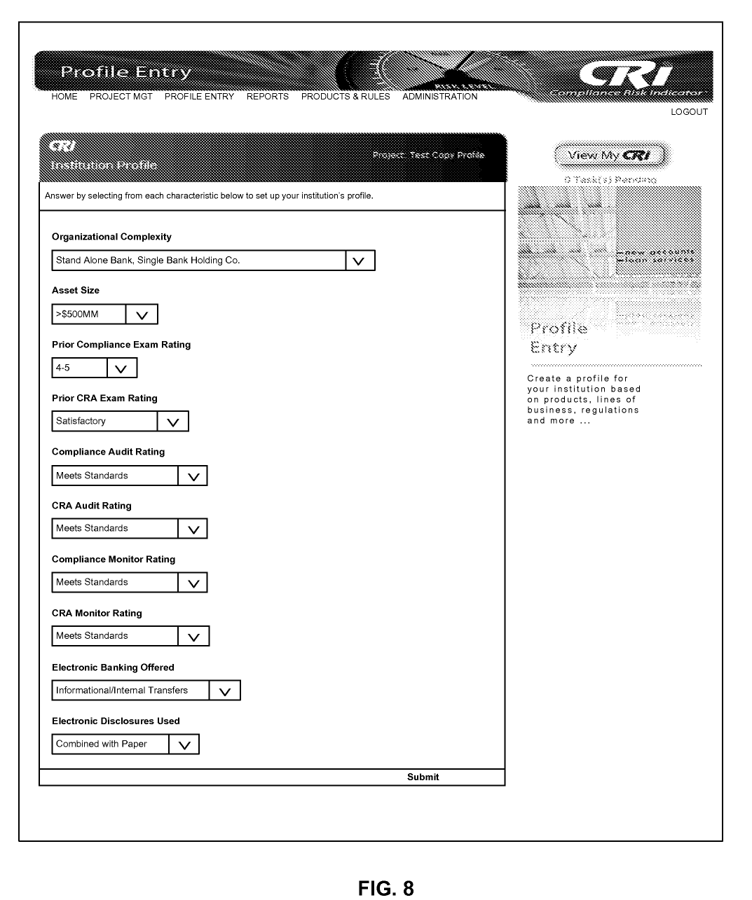

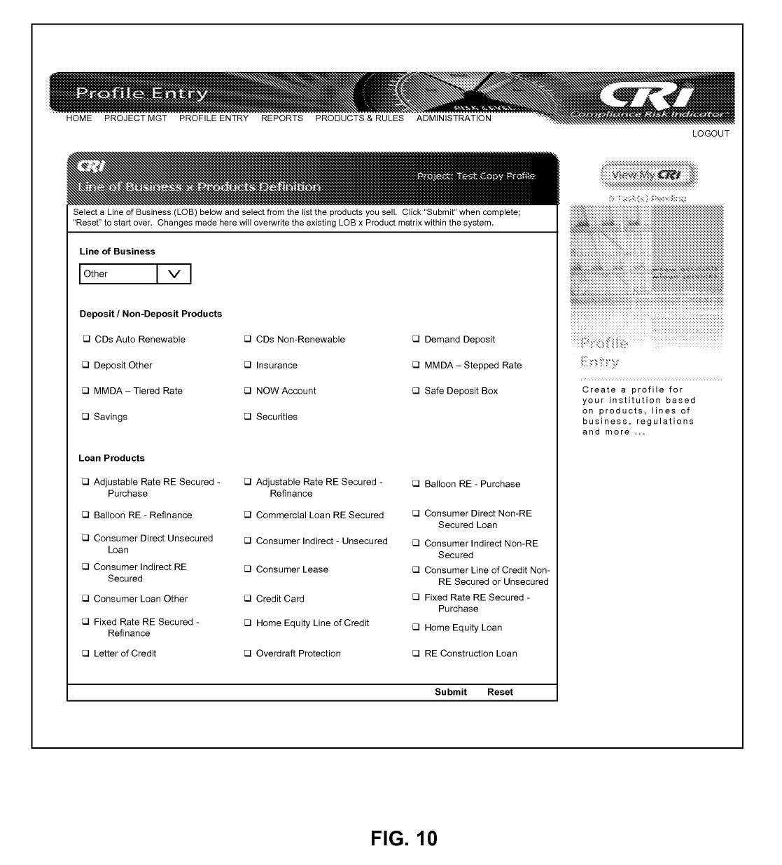

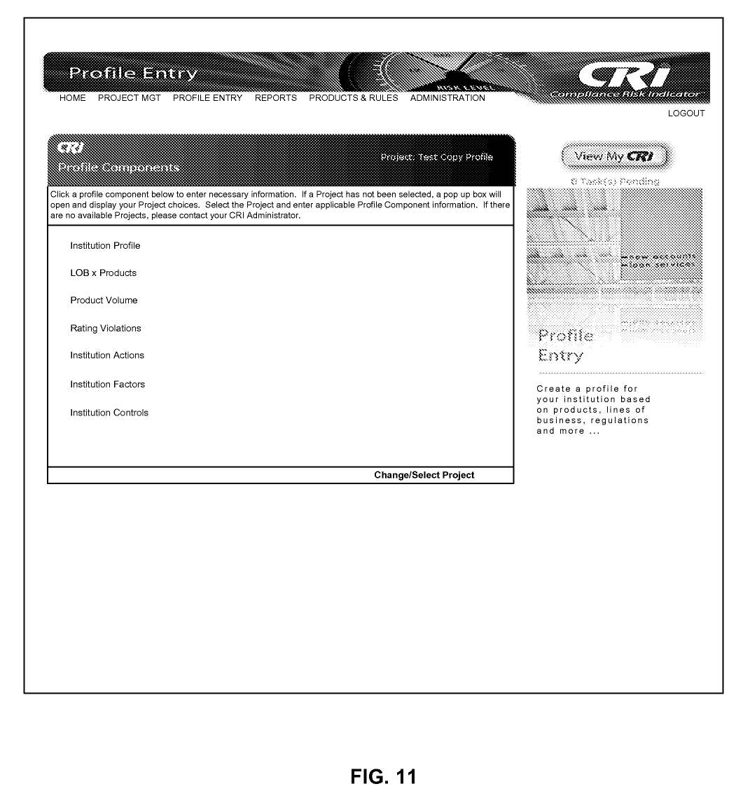

The products module 120 may be configured to receive risk factors associated with the different products, services or process of the institution. The risk factors may be predetermined risk factors that are presented to the user for selection via a user interface. In some embodiments the user may generate or provide risk factor information via the user interface. The profile module 100 can be configured to receive a set of profile entry or information for determining risk factor, for example, a set of institution profile entry that includes information regarding the business activities of a business entity or institution. FIG. 10 illustrates an example user interface for receiving or selecting profile entry. The business activities may relate to the business or institutions products, services or processes, for example. The entity profile module 90 may be configured to categorize each set of entry into projects, so that a user can select an existing project for editing or creating a new project for entering a new set of entry. In some embodiments the entity profile module 90 comprises a user interface for receiving the set of institution profile entry, for example, from the business entity. The entries received or predetermined may be identified as risk factors for calculating risk levels. The risk factors can also include the products, services, processes and controls of the business entity. An example of such a user interface is illustrated in FIG. 10. The user interface may be a secure web-based user interface that is accessible to a user. In another embodiment, the user interface may prompt the user to select or enter a project name for the set of entry. The user interface may also prompt the user to enter the necessary risk factors associated with the set of institution profile entry. The products and services of the entity can themselves be used as risk factors for the purpose of risk calculation. FIG. 10 is an example of a user interface illustrating a list of products or services associated with a line of business according to an embodiment. Accordingly the risk factors associated with the set of institution profile entry may include institution or business entity profile, and other business entity components including line of business of the institution, the product volume of the different products offered by the institution, rating violation, institution actions, institution factors and institution controls. An example of a user interface including the business entity components is illustrated in FIG. 11. The business entity or institution profile may include information relating to the organizational complexity. For example, whether the institution is a stand alone bank, single bank holding company, bank holding company with multiple charters in a single state, multi-state bank or bank holding company with non bank subsidiaries etc. Other business entity profile information may include asset size, prior compliance exam rating, prior Community Reinvestment Act (CRA) exam rating, compliance audit rating, CRA audit rating, compliance monitor rating, CRA monitor rating, electronic banking offered, transfers/account opening, electronic disclosures used etc. FIG. 8 illustrates an example user interface for receiving various characteristics for setting up the institutions profile. The line of business of the institution may include retail, private banking, business banking, trust, mortgage lending, consumer lending, asset management, credit card, investments and other lines of businesses. The product volume may be expressed in dollars or in some predetermined unit as illustrated in the user interface diagram of FIG. 7. Some examples of products and services associated with different lines of businesses include Deposit/Non-Deposit Products such as certificate of deposits (CDs) Auto Renewable, CDs Non-Renewable, Demand Deposit, Deposit (Other), Insurance, Money Market Deposit Account (MMDA)—Stepped Rate, MMDA—Tiered Rate, NOW Account, Safe Deposit Box, Savings and Securities. The products associated with different lines of businesses can also include Loan Products, for example, Adjustable Rate RE Secured—Purchase, Adjustable Rate RE Secured—Refinance, Balloon RE—Purchase, Balloon RE—Refinance, Commercial Loan RE Secured, Consumer Direct Non-RE Secured Loan, Consumer Direct Unsecured Loan, Consumer Indirect—Unsecured, Consumer Indirect Non-RE Secured, Consumer Indirect RE Secured, Consumer Lease, Consumer Line of Credit Non-RE Secured or Unsecured, Consumer Loan Other, Credit Card, Fixed Rate RE Secured—Purchase, Fixed Rate RE Secured—Refinance, Home Equity Line of Credit, Home Equity Loan, Letter of Credit, Overdraft Protection and RE Construction Loan.

The rating violations establish, for example, the different levels of violation of a regulation or rule. The rating violations may be established as a matrix of risk factors that weighs the result of historical internal and external examinations and violations weighted by the regulations. For example a rule may be established by a regulatory body, for example, the Federal Deposit Insurance Corporation (FDIC) and the Federal Reserve Board. Any violation of the rule may be categorized into different rating level. For example, a violation of the regulatory rule caused by a single act may be categorized as a level 2 violation and may warrant a warning to the business entity. Further violations of higher levels may lead to suspension or revocation of a license, for example. The institution actions may include the actions filed against the institution or business entity. The institutions actions may be established as a matrix of risk that weighs the results of historical complaints, lawsuits, and Attorney General Actions weighted by the regulations, for example. In one embodiment, the institution actions can be categorized into complaints, lawsuits or attorney general actions, for example. Some of the actions against the institution may be filed under Anti-Trust Acts, Bank Bribery Act, Children's Online Privacy Protection Rule, Controlling the Assault of Non-Solicited Pornography and Marketing, Debt Cancellation Contracts And Debt Suspension Agreements, Electronic Signatures in Global and National Commerce Act, Fair Credit Reporting Act, Fair Debt Collection Practices, Fair Housing Act, Fair Housing Home Loan Data System, FDIC Insurance Rules, Guidelines Establishing Information Security Standards, Homeowners Protection, Homeownership Counseling, Nondiscrimination Requirements, Real Estate Settlement Procedures Act (RESPA), Regulation AA—Unfair or Deceptive Credit Practices, Regulation B—Equal Credit Opportunity Act, Regulation BB—Community Reinvestment, Regulation C—Home Mortgage Disclosure, Regulation CC—Expedited Funds Availability, Regulation D and Q—Reserve Requirements/interest on Deposits, Regulation DD—Truth in Savings, Regulation E—Electronic Funds Transfer, Regulation F—Interbank Liabilities, Regulation G—Disclosure/Reporting of CRA Related Agreements, Regulation H—Bank Security Procedures, Regulation H—Consumer Protection in Sales of Insurance/OCC 94-13, Regulation H—Flood, Regulation M—Consumer Leasing, Regulation O—Loans to Insiders, Regulation P and FF—Privacy of Consumer Financial and Medical Information, Regulation U—Credit for Margin Stock, Regulation W—Transactions with Affiliates, Regulation Y—Bank Holding Company, Regulation Y—RE Appraisal, Regulation Z—Adjustable Rate Mortgage, Regulation Z—Closed End, Regulation Z—Credit Card, Regulation Z—Fixed Rate Mortgage, Regulation Z—Home Equity Line of Credit, Regulation Z—Other Open End, Regulation Z—RE Construction, Right to Financial Privacy, Servicemembers Civil Relief Act, Telemarketing Sales Rule, Telephone Consumer Protection Act, Tying Arrangements, Unfair And Deceptive Practices Act, Weblinking Risks and Management Techniques, etc.

The rules module 190 may be coupled to the factors module 130, the inherent risk module 140 and the residual risk module 150 and configured to receive rules or regulations governing the business entity. Some of the regulations of the rules module include Anti-Trust rules, Anti-Tying rules, BHC, BPA, Bank Bribery, CA Fear Act Policy, CAN-SPAM, COPPA, Debt Cancel/Suspense, E-Sigh, ECOA, FCRA, FDCPA, FDIC, FHA, FHHLDS, Fair Lending, HMDA, HOPA, Home Ownership Counselling, INFO SEC, Privacy, Re Appraisal, RESPA, RTFPA, Regulation AA, Regulation BB, Regulation CC, Regulation D/Q, Regulation DD, Regulation E, Regulation G, Regulation O, Regulation W, SCRA, TCPA, TILA Adjustable Rate MTG, TILA Credit Card, TILA Fixed Rate MTG, HELOC, RE Construction, Telemarketing, UDAP, Weblinking, etc. Other rules, for example rule not included in the system, may be added and mapped by the client. For example, state laws can be entered into the system for inclusion in the risk level calculation.

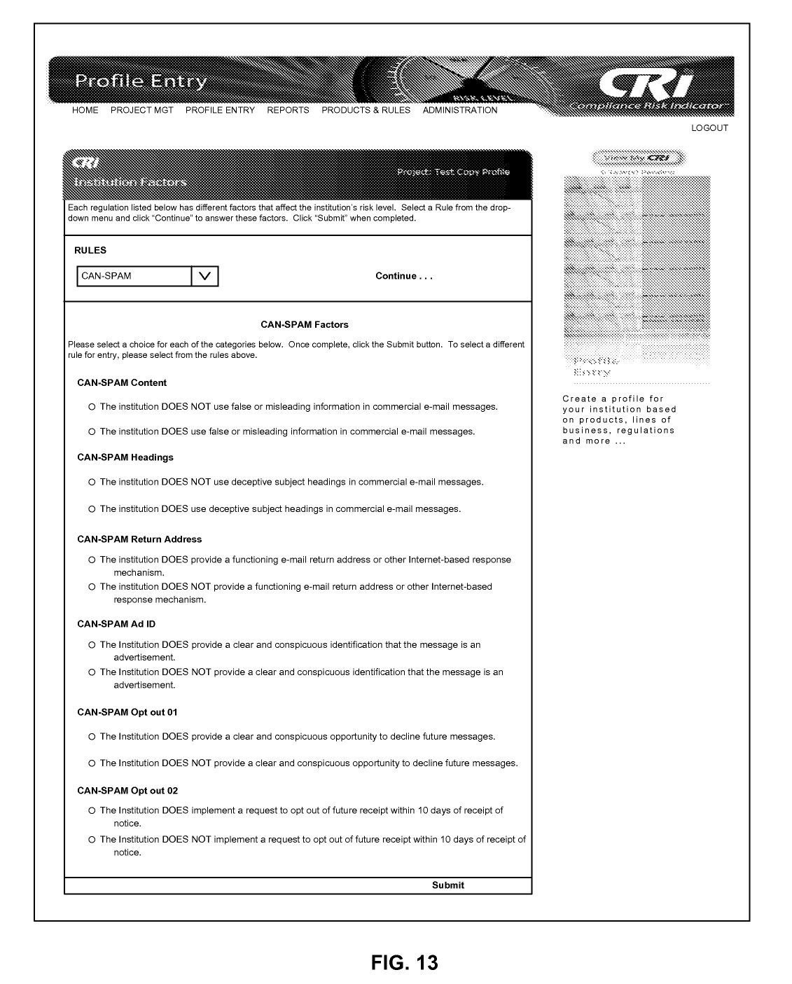

The factors module 130 may be coupled to the rules module 190, the institution controls module 110, the inherent risk module 140 and the residual risk module 150 and configured to establish risk factors that affect the institutions risk level. The products or services of the institution that are associated with rules or regulations, for example, may have different institution factors that affect the institutions risk level. A user may be prompted to select a rule from a drop-down menu in the user interface and to select or provide the risk factor information associated with the different rules or regulations. The institution factors may be obtained based on the users answer to risk related questions presented to the user via the user interface. The institution factors may be used by the inherent risk module 140 and/or the residual risk module 150 for analysis or calculation of risk levels or stored in the storage device 45 for future use. The institution factors are examples of risk factors that are internal or external to the institution for identifying and quantifying potential and actual risk level based on a business activity volume and the severity of applicable penalties, for example. In some embodiments the actual and/or potential risk level may be identified and quantified based on historic compliance performance, complaints and litigation or attorneys general actions against the institution or business entity. The actual and/or potential risk level may also be based on status of regulatory defined key risk indicators, such as staff turnovers or changes in products, markets, products, operations, systems and vendors. Regulatory and public focused changes or events may also impact the actual risk level. FIG. 13 is an example screen shot of a user interface institution factors that affect the institution's risk level.

The following are examples of risk factors information associated with various rules or regulations.

### FDIC Factors

### Insurance Coverage

1. Account opening documents DO clearly identify the ownership type of each account.
2. Account opening documents DO NOT clearly identify the ownership type of each account.

### Insurance Coverage

1. Account opening documents ARE retained for 7 years after the account is closed.
2. Account opening documents ARE NOT retained for 7 years after the account is closed.

### Regulation AA Factors

1. The institution DOES NOT acquire loans originated by other creditors.
2. If the institution acquires loans originated by other creditors, it DOES refrain from enforcing any of the prohibited practices.
3. If the institution acquires loans originated by other creditors, it DOES NOT refrain from enforcing any of the prohibited practices.

### ANTI-TRUST Factors

### Antitrust Regulations

1. The institution IS aware and mindful of the provisions of the Sherman Antitrust Act.
2. The institution IS NOT aware and mindful of the provisions of the Sherman Antitrust Act.

The internal controls module 110 may be coupled to the rules module 190 and configured to establish controls or steps that are already taken by the institution that affect the risk levels of the institution according to different regulations or to determine a mitigation value for a plurality of risk mitigation activities of the entity and calculate an internal controls value/factor for the entity. Accordingly the internal controls module 110 can be configured to determine a mitigation value for a plurality of risk mitigation activities of the entity and calculate an internal controls value for the entity. The internal controls factors may be used to rate the institutions internal controls. The institutions internal controls and steps may be tailored to mitigate the institutions exposure to risk. In one embodiment the internal controls module 110 may be configured to receive the institution internal controls or steps from a user via the user interface. The user interface may also have predetermined controls or steps that may be selected according to the controls or steps taken by the institution. In one embodiment, the user interface may prompt the user to select a rule or regulation and to select a predetermined control or step that is already enacted by the institution. The internal controls module 110 may be configured to receive custom controls or steps established or enacted by a user. The following are examples of selectable controls or steps associated with various rules or regulations.

### ANTI-TRUST Controls

### Anti-Trust Regulations Monitoring

1. A process IS NOT in place to verify the content of any contract relative to prohibited language prior to consummation.
2. A process IS in place to verify the content of any contract relative to prohibited language prior to consummation.

### Anti-Trust Regulations Training

1. Management has not provided adequate resources or training for anti-trust.
2. Management provides adequate resources and training for anti-trust.
3. Anti-trust training programs are effective, and the necessary resources have been provided to ensure compliance.

### FDIC Controls

### Insurance Coverage

1. Bankers ARE NOT provided training relative to assisting customers in determining FDIC insurance coverage.
2. Bankers ARE provided training relative to assisting customers in determining FDIC insurance coverage.

FIG. 11 is an example screen shot of a user interface illustrating components of an institution profile according to an embodiment of the present invention. A user can select one of the profile components including the institution profile, the line of business of the institution, product volume, rating violations, institution actions, institution factors and institution controls. For example, a user can select the institution profile and enter all the necessary information relating to the institution profile.

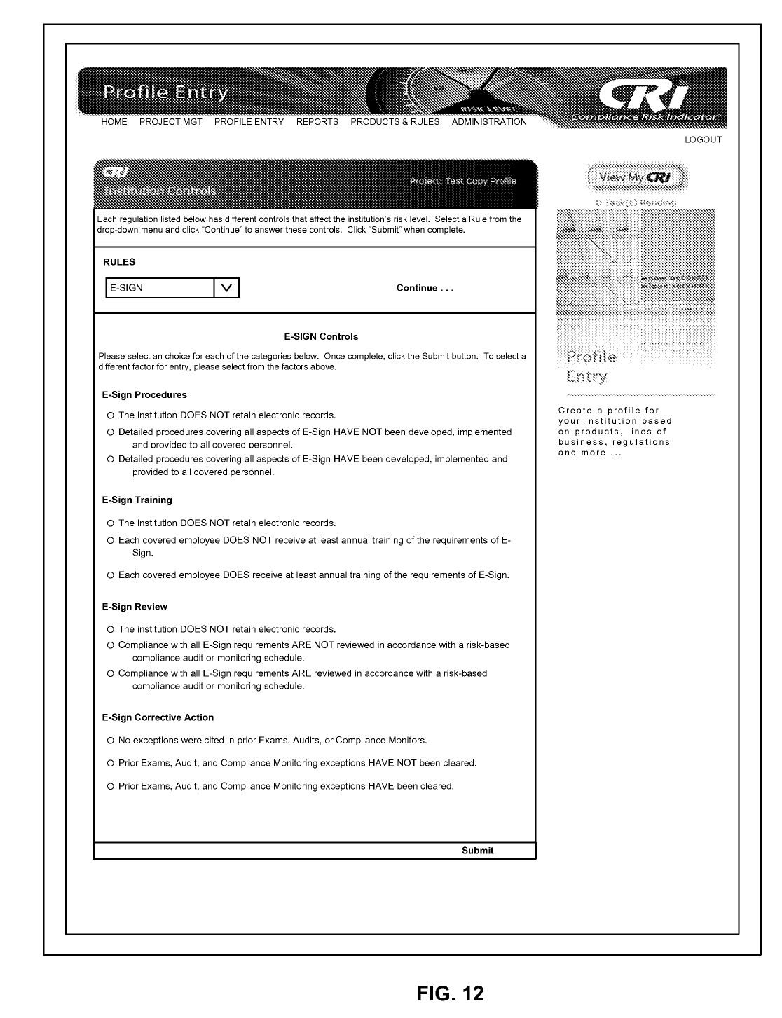

FIG. 12 is an example screen shot of a user interface for selecting or entering the institution controls in relation to a specific rule.

The inherent risk module 140 may be coupled to the rules module 190 and configured to calculate or determine a risk value of the institutions/businesses activities relating to the products, services or processes, for example. The risk value may be associated with one or more rules or regulations, for example, the rules or regulations associated with the rules module 190. The inherent risk module 140 may also be configured to calculate or determine an inherent risk of the institutions activities relating to the products, services or processes or the overall inherent risk of the institution or business entity. The inherent risk may be calculated in accordance the overall institution, an enterprise-wide, the lines of business of the institution, the products or services offered by the institution or by the rules or regulations. The products and/or services, for example, may be selected from the products and/or services with respect to the profile module 100. The inherent risk module 140 may also be configured to adjust the inherent risk relative to its significance for the institution. For example, if it is decided, by the institution, that a product or service is of low risk significance to the institution, that information is incorporated into the inherent risk calculation thereby adjusting the inherent risk calculation. In one embodiment the total inherent risk may be the sum of various risk factors including the inherent risk factor (IR), enforcement actions risk factor (EA), litigation actions risk factor (LA), external significance risk factor (ES), rating violations risk factor (RV), institution actions risk factor (IA) and internal significance risk factor (IS). The risk values are determined at the inherent risk module and/or the residual risk module 150 illustrated in FIG. 2 and may be based on information established or obtained by the profile module 100, factors module 130, products module 120 or the internal controls module 110, for example. IR may be, for example, the indicia of risk comprising the institutions profile or financial profile (IP), its chosen product line (for example, line of business of products (LOBP)) and its internal factors of operation (IF). IP may be the indicia of risk of a financial institution based on its assets, business organization, high level prior ratings and integration of electronic configuration of information. This information may be determined based on the risk factors associated with the institution's profile, for example, at the profile module 100 illustrated in FIG. 2 above. LOBP may be the indicia of risk of the institution based on its choice of product lines and their applicable regulatory risk. LOBP may be based on the information received at the profile module 100. IF may be the indicia of risk of a financial institution based on its discrete operational choices as measured against matrices of risk for each regulation involved. IF may be determined based on information from the factors module 130, for example. Accordingly IR may be expressed as

IR=(IP+LOBP+IF)

And the total inherent risk (IR_{Total}) me be determined by the following formula:

IR_{Total}=IR+EA+LA+ES+RV+IA+IS

where EA is the enforcement actions risk factor, LA is the litigation actions risk factor, ES is the external significance risk factor, RV is the ratings violations risk factor, IA is the institutions actions risk factor and IS is the internal significance risk factor. The ES may be expressed as a matrix of risk comprising the weighting of differing regulations by their risk of loss based on the nature of the regulations penalties. The IS may be expressed as a matrix of risk that weighs the significance of a particular regulations impact to the financial operation by the product lines on sale and their applicable regulations.

The residual risk module 150 may be coupled to the rules module 190, the internal controls module and the inherent risk module 140. The residual risk module may be configured to calculate an overall residual risk or residual risk level for the business entity based upon the inherent risk in accordance with the calculation in the inherent risk module 140 and an internal control factor generated by the internal control module 110. The residual risk may be determined by applying the internal control factor/value to the inherent risk determined by the inherent risk module 140. The total residual risk (RR_{Total}) may be determined by the following formula:

RR_{Total}=IR+EA+LA+ES+RV+IA+IS−IC

where IC is the internal controls risk factor. IC can be the indicia of risk that measures the controls in place within the institution that serve to reduce the risk by regulation, for example, and may be based on information associated with the internal controls module 110. The risk level calculation schedule for the inherent risk module 140 and the residual risk module 150 may be user defined.

What can be seen from the above calculations of IR_{Total} and RR_{Total} is that the impact of the inherent risk of a system as applied to the matrices of risk presented by the internal and external factors, and offset by controls in place to reduce the risk results in the total risk of operation. The system operates by collecting the information to develop the indicia of risk and weighted risk matrices and then calculates the sum of these impacts, thereby determining the overall risk. The indicia of risk may be based on information received via the user interface with respect to the different modules. For example information relating to the institution may be received at the profile module 100 via the user interface. The user interface may present the user with form based questions that allow the user to provide information regarding the business entity or institution. The questions may be specifically designed to gather the key elements of the institutions operations that create risk. Some of the matrices of risk may be previously stored in the storage device 45 that evaluate the impact of those indicia of risk to approximate the risk presented by the regulations or operations covered by the questions. Some of the indicia of risk include federal regulations that may be evaluated by determining the detailed compliance requirements and researching and examining industry practices to marry the compliance requirement to the practice which creates risk to varying degrees. The results may be expressed in matrices and the matrices are used to develop business practice questionnaires that may be presented to a user via the user interface to determine the indicia of risk that certain practices create against an applicable regulation. Some of the matrices may be weighted by the quantity, expressed in percent for example, of operations that the product line presents to the overall business operation. These become rated factors to apply to the regulations detailed risk. In some embodiments a user is allowed to add their own regulation and products to the system.

The forecasting module 170 may be coupled to the residual risk module 150 and configured to forecast the effect of certain events or factors or changes on the residual risk level to aid in the overall risk management. The events or factors may be internal or external to the institution and may be established in the factors module 130. Multiple risk projects may be run concurrently. In one embodiment, in order to analyze the risk level impact of a change, such as a new product, the user or client simply copies the affected risk profile to a new project, for example, inputs the changes and runs the risk calculations. A risk profile may include a set of entry associated with a project. The projects may relate to risk calculations at various levels, for example, enterprise-wide, institutions, lines of business, products and regulations.

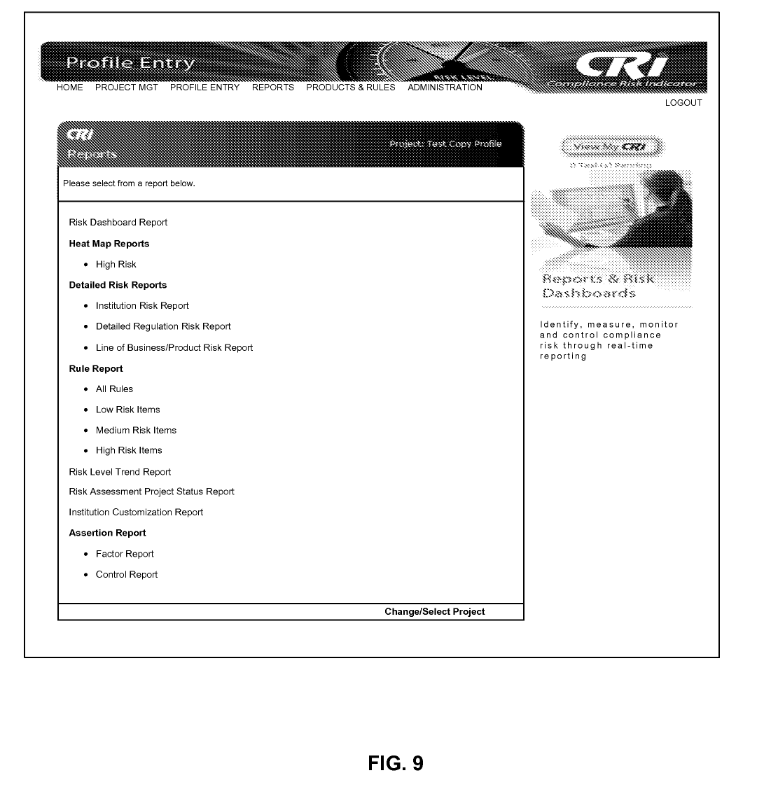

The reporting module 160 may be coupled to the inherent risk module 140 and the residual risk module 150. The reporting module 160 may be configured to generate reports and can allow reports, for example inherent and residual risk level reports, to be defined and customized. Standard templates or pre-defined reports are available that take advantage of an established standard for risk management report. The reporting module 160 may also include a risk dashboard that provides risk levels for enterprise-wide, various institutions, lines of business products and regulations. The risk dashboard may also include a variety of risk management reports such as heat maps, risk level and trend reports, risk factor and internal controls report, etc. The reports may be available at the regulation, product, institution or enterprise level. The heat map report may include different designations of risk levels including low risk designation, medium risk designation or high risk designation. In addition the reporting module may include a detailed risk reports, rule report, risk level trend report, risk assessment project status report, institution customization report, assertion report, missing assertion report, external factors report, violations report, regulation inherent risk report, profile entry reports. The detailed risk report can include institution risk report, detailed regulation risk report and/or line of business/product risk report. The rule report may include all rules, low risk items/rules, medium risk items/rules and/or high risk items/rules. The assertion report may include a factor report and/or an internal control report. The missing assertion report may include missing factor report and/or missing internal control report. The external factors report may include enforcement actions, litigation actions, and/or external factors search. The violations report may include regulatory violations report, audit violations report and/or monitoring violations report. The profile entry reports may include institution actions report and/or line of business and products report. FIG. 9 is an example user interface diagram illustrating screens of the various reports that may be generated by the reporting module 160.

The audit module 180 encompasses the tools that an auditor can use to validate and track the risk management performance, for example, of the business entity or institution. The auditor module may be accessible to an external or internal auditor via a user interface. The audit module 180 may be configured to receive reports from the reporting module 160 for analysis by an external or internal auditor. The audit module may be configured to receive information associated with the auditing process from the different modules in the risk assessment server 40.

FIG. 3 is a flow diagram illustrating a high level process for calculating an internal control value according to an embodiment of the present invention. The illustrated process can be carried out by the risk assessment server 40 that was previously described with respect to FIG. 2. Initially, in step 200, determine the set of institution profile entry according to the profile module 100 described in FIG. 2. The process then proceeds to step 210 where the internal controls are determined according to internal controls module 110 of FIG. 2 above. Finally in step 220, an internal controls value/factor is calculated by the internal controls module.

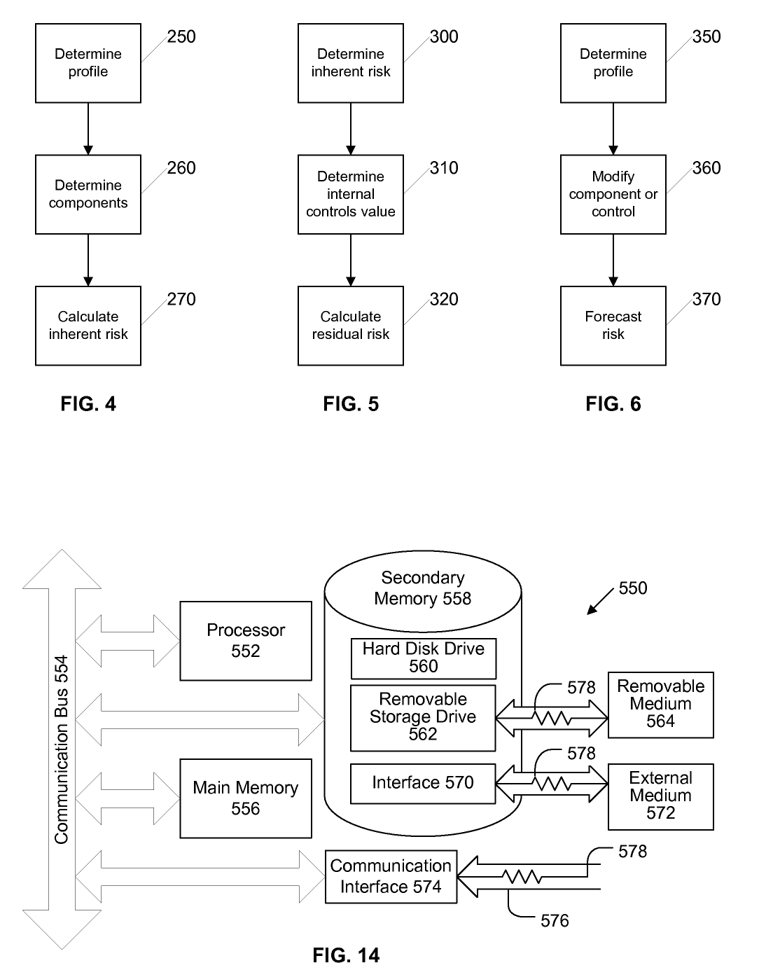

FIG. 4 is a flow diagram illustrating a high level process for calculating an inherent risk assessment according to an embodiment of the present invention. The illustrated process can be carried out by the risk assessment server 40 that was previously described with respect to FIG. 2. Initially, in step 250, a set of institution profile entry for the business entity may be determined at the profile module 100 illustrated in FIG. 2 above. The process then proceeds to step 260 where the business entity components are determined at the profile module 100 illustrated in FIG. 2 above. Finally in step 270 the inherent risk level is calculated at the inherent risk module 150 illustrated in FIG. 2 above.

FIG. 5 is a flow diagram illustrating a high level process for calculating a residual risk assessment according to an embodiment of the present invention. The illustrated process can be carried out by the risk assessment server 40 that was previously described with respect to FIG. 2. Initially, in step 300, an inherent risk level is determined by the inherent risk module 140 illustrated in FIG. 2 above and according to the process of FIG. 4. The process then continues to step 310 where an internal controls factor/value is determined at the internal controls module 110 illustrated in FIG. 2 above and according to the process of FIG. 3. Finally in step 320 the residual risk level is calculated at the residual risk module 150 illustrated in FIG. 2 above based on the internal controls value and the inherent risk value, for example.

FIG. 6 is a flow diagram illustrating a high level process for calculating a forecast risk assessment according to an embodiment of the present invention. The illustrated process can be carried out by the risk assessment server 40 that was previously described with respect to FIG. 2. Initially, in step 350, determine the set of institution profile entry according to the profile module 100 described in FIG. 2. The process then proceeds to step 360 where the business entity components determined at the profile module 100 and/or the internal controls determined according to internal controls module 110 are modified according to anticipated changes, for example, in activities, events, products, rules or regulations. Finally in step 370 the forecast risk is calculated at the forecasting module 170 illustrated in FIG. 2 above.

FIG. 14 is a block diagram illustrating an example computer system 550 that may be used in connection with various embodiments described herein. For example, the computer system 550 may be used in conjunction with the client or server device previously described with respect to FIG. 1. Other computer systems and/or architectures may also be used as will be understood by those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for determining compliance risk assessment comprising:
an entity profile module configured to receive information regarding the business activities and risk mitigation activities of an entity;
an inherent risk module configured to determine a risk value for a plurality of business activities of the entity and calculate an inherent risk for the entity;
an internal controls modules configured to determine a mitigation value for a plurality of risk mitigation activities of the entity and calculate an internal controls value for the entity;
a residual risk module configured to calculate an overall residual risk for the entity based upon the inherent risk for the entity and the internal controls value for the entity.

2. The entity profile module of claim 1, further comprising a profile module configured to receive information regarding the business activities including risk factors associated with the business entity profile and business entity components.

3. The entity profile module of claim 2, wherein the business entity profile includes risk factors associated with the organizational complexity of the entity.

4. The entity profile module of claim 2, wherein the business entity profile includes risk factors selected from the group consisting of asset size of the entity, prior compliance exam rating, CRA audit rating, compliance monitor rating, CRA monitor rating, electronic banking offered, transfers/account opening and electronic disclosure used.

5. The entity profile module of claim 2, wherein the business entity components includes risk factors selected from the group consisting line of business of the entity, the product volume of the different products offered by the entity, rating violation, institution actions, institution factors, and institution controls.

6. The entity profile module of claim 1, further comprising a factors module configured to receive external or internal risk factors associated with the products or services of the entity.

7. The entity profile module of claim 6, wherein the risk factors are based on business activity volume and the severity of applicable penalties.

8. The entity profile module of claim 6, wherein the risk factors received are selected from the group consisting of historic compliance, complaints and litigation, actions against the entity, status of regulatory defined key risk indicators, staff turnovers, changes in products, changes in markets, changes in products, operations, systems, vendors and regulatory and public focused changes.

9. The entity profile module of claim 1, further comprising a products module configured to receive information regarding the business activities including risk factors associated with products and services offered by the business entity.

10. The entity profile module of claim 1, further comprising a forecasting module configured to forecast the effect of certain risk factors associated with certain events or changes affecting the products or services of the entity.

11. The entity profile module of claim 1, further comprising a rules module configured to receive internal and external regulations governing the entity.

12. The system of claim 1, further comprising a reporting module configured to generate reports from the entity profile module, the inherent risk module, the residual risk module and the internal controls module.

13. The system of claim 1, further comprising an audit module configured to track the risk management performance of the entity.

14. The system of claim 13, wherein the audit module is configured to receive risk related information from the entity profile module for tracking risk management performance of the entity.

15. The system of claim 13, wherein the audit module is configured to receive risk related information from the inherent risk module and the residual risk module for tracking risk management performance of the entity.

16. The system of claim 13, wherein the audit module is configured to receive reports from a reporting module configured to generate reports from the entity profile module, the inherent risk module, the residual risk module and the internal controls module.

17. The system of claim 16, wherein the reports are received and analyzed by an auditor.

18. A method for determining compliance risk assessment comprising:
receiving information regarding business activities and risk mitigation activities of an entity at an entity profile module;
determining a risk value for a plurality of business activities of the entity at an inherent risk module;
calculating an inherent risk for the entity at the inherent risk module;
determining a mitigation value for a plurality of risk mitigation activities of the entity at an internal controls module;
calculating an internal controls value for the entity at the internal controls module;
calculating an overall residual risk for the entity based upon the inherent risk for the entity and the internal controls value for the entity at a residual risk module.

19. The method of claim 18, further comprising determining receiving information regarding business the business activities including risk factors associated with business entity profile and business entity components.

20. The method of claim 19, wherein the business entity profile includes risk factors selected from the group consisting of organizational complexity of the entity, asset size of the entity, prior compliance exam rating, CRA audit rating, compliance monitor rating, CRA monitor rating, electronic banking offered, transfers/account opening and electronic disclosure used.

21. The method of claim 19, wherein the business entity components includes risk factors selected from the group consisting line of business of the entity, the product volume of the different products offered by the entity, rating violation, institution actions, institution factors, and institution controls.

22. The method of claim 18, further comprising forecasting module the effect of certain risk factors associated with certain events or changes affecting the products or services of the entity.

23. The method of claim 18, further comprising receiving internal and external regulations governing the entity at a rules module.

24. The method of claim 18, further comprising generating reports from information received from the entity profile module, the inherent risk module, the residual risk module and the internal controls module.
